(19) United States
(12) Patent Application Publication
(10) Pub. No.: US 2025/0240042 A1
(43) Pub. Date: Jul. 24, 2025

(54) ELECTRONIC DEVICE

(71) Applicant: Lenovo (Beijing) Limited, Beijing (CN)

(72) Inventors: Wenlei WANG, Beijing (CN); Dafei MO, Beijing (CN)

(21) Appl. No.: 19/015,331

(22) Filed: Jan. 9, 2025

(30) Foreign Application Priority Data
Jan. 19, 2024 (CN) 202410081071.2

(51) Int. Cl. H04B 1/04; H01Q 1/52; H01Q 21/30

(52) U.S. Cl. CPC H04B 1/0483; H01Q 1/521; H01Q 21/30

(57) ABSTRACT

An electronic device includes a first antenna, a second antenna, and a target device. The first antenna is arranged at a first position and is configured as a transmission antenna to radiate a first radio frequency (RF) signal of a target frequency band. The second antenna is arranged at a second position different from the first position and is configured as a receiving antenna to receive a second RF signal of the target frequency band. The target device is arranged at a third position and is configured to generate a third RF signal of the target frequency band. The third RF signal is used to reduce an impact of the first RF signal on the second antenna receiving the second RF signal. The third position is different from the second position and the first position.

### CROSS-REFERENCE TO RELATED APPLICATION

The present disclosure claims priority to Chinese Patent Application No. 202410081071.2, filed on Jan. 19, 2024, the entire content of which is incorporated herein by reference.

### TECHNICAL FIELD

The present disclosure is related to the electronic device technology field and, more particularly, to an electronic device.

### BACKGROUND

An antenna is an important part in an electronic device and is configured to send and receive a signal. Often, the electronic device includes a plurality of antennas. When the plurality of antennas are close to each other, the plurality of antennas affect each other. To avoid the impact from a neighboring antenna, distances among the plurality of antennas are added for adjustment.

However, by increasing the distances between the antennas to avoid impacting each other, the space utilization of the electronic device is reduced.

### SUMMARY

An aspect of the present disclosure provides an electronic device, including a first antenna, a second antenna, and a target device. The first antenna is arranged at a first position and is configured as a transmission antenna to radiate a first radio frequency (RF) signal of a target frequency band. The second antenna is arranged at a second position different from the first position and is configured as a receiving antenna to receive a second RF signal of the target frequency band. The target device is arranged at a third position and is configured to generate a third RF signal of the target frequency band. The third RF signal is used to reduce an impact of the first RF signal on the second antenna receiving the second RF signal. The third position is different from the second position and the first position.

### BRIEF DESCRIPTION OF THE DRAWINGS

FIG. 1 illustrates a schematic flowchart of a decoupled network in related technologies.

FIG. 2 illustrates a schematic structural diagram of an electronic device according to some embodiments of the present disclosure.

FIG. 3 illustrates a schematic structural diagram of an antenna module of an electronic device according to some embodiments of the present disclosure.

FIG. 4 illustrates a schematic operation principle diagram of an antenna module of an electronic device according to some embodiments of the present disclosure.

FIG. 5 illustrates a schematic operation principle diagram of another antenna module of an electronic device according to some embodiments of the present disclosure.

FIG. 6 illustrates a schematic operation principle diagram of another antenna module of an electronic device according to some embodiments of the present disclosure.

FIG. 7 illustrates a schematic structural diagram of another antenna module of an electronic device according to some embodiments of the present disclosure.

FIG. 8a illustrates a schematic structural diagram of a target device of an electronic device according to some embodiments of the present disclosure.

FIG. 8b illustrates a schematic structural diagram of another target device of an electronic device according to some embodiments of the present disclosure.

FIG. 9 illustrates a schematic diagram showing an operation curve of an antenna module of an electronic device according to some embodiments of the present disclosure.

FIG. 10 illustrates a schematic diagram showing a phase difference change curve of a first radio frequency signal without a target device according to some embodiments of the present disclosure.

FIG. 11 illustrates a schematic diagram showing a phase difference change curve of a first radio frequency signal with a target device according to some embodiments of the present disclosure.

FIG. 12 illustrates a schematic diagram showing an insulation degree change curve of an electronic device according to some embodiments of the present disclosure.

FIG. 13 illustrates a schematic structural diagram of another electronic device according to some embodiments of the present disclosure.

FIG. 14 illustrates a schematic structural diagram of another electronic device according to some embodiments of the present disclosure.

FIG. 15 illustrates a schematic structural diagram of another electronic device according to some embodiments of the present disclosure.

### DETAILED DESCRIPTION OF THE EMBODIMENTS

Embodiments of the present disclosure are described in detail in connection with the accompanying drawings of embodiments of the present disclosure. Apparently, the described embodiments are merely some embodiments of the present disclosure, not all embodiments. Based on embodiments of the present disclosure, all other embodiments obtained by those of ordinary skill in the art without creative efforts are within the scope of the present disclosure.

To make the above objectives, features, and advantages of the present disclosure more comprehensible, the present disclosure is further described in detail below in connection with the accompanying drawings and embodiments of the present disclosure.

As mentioned in the background section, increasing the distances between antennas can mitigate mutual impacts between the antennas. However, a lot of space of the electronic device can be taken. Thus, the layout space of other assemblies of the electronic device can be reduced, which is not beneficial for the electronic device to be developed with multiple functions.

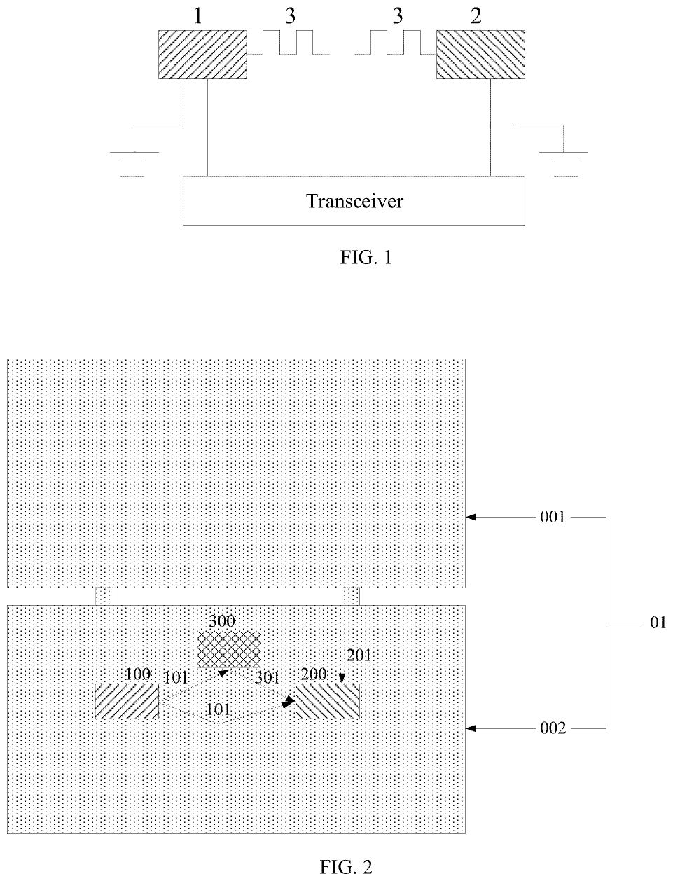

For the above issue, the existing solution includes arranging an isolation unit to reduce the coupling between the antennas. For example, the antennas can be isolated by using a decoupling network. As shown in FIG. 1, a first antenna 1 and a second antenna 2 need to be connected to the decoupling network 3 and interact with the structure of the connected decoupling network 3 to realize isolation. However, a large space can be taken. In some other embodiments, a radio frequency signal radiated by at least one antenna can be reduced to reach the strength of another antenna. For example, an isolation wall can be configured to perform physical isolation to hinder the purpose of the transmission of the electronic waves the decoupling network internal structures interact to achieve isolation. However, this requires significant space. Alternatively, the intensity of RF signals radiated by one antenna reaching another antenna can be reduced by using isolation walls for physical separation. This prevents electromagnetic waves from passing through and achieving isolation. However, due to the radiation direction of antennas, such isolation walls need to be relatively high, making them unsuitable for devices like mobile phones, tablets, and laptops, resulting in limited practicality.

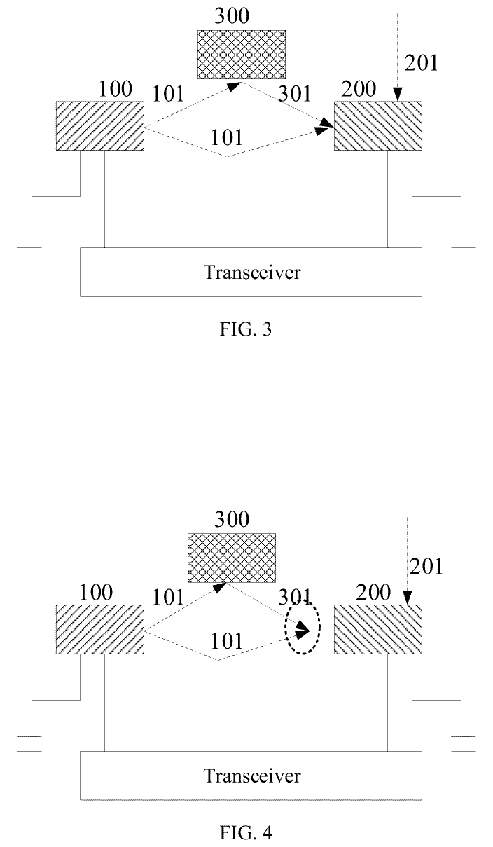

Based on this, the present disclosure provides an electronic device, as shown in FIGS. 2 and 3. The electronic device includes a device body 01, and a first antenna 100, a second antenna 200, and a target device 300 arranged on the device body 01.

The first antenna 100 is arranged at the first position. The first antenna 100 can be used as a transmission antenna and configured to radiate a first RF signal 101 at the target frequency band.

The second antenna 200 is arranged at a second position different from the first position. That is, the second antenna 200 does not overlap with the position of the first antenna 100, and can be used as a receiving antenna to receive a second RF signal 201 at the target frequency band. The second antenna 200 does not overlap with the position of the first antenna 100. The second antenna 200 can be located in a far-field polarization direction of the first antenna 100. That is, the second antenna 200 can be located in the main radiation direction of the first antenna 100. Thus, a strong mutual coupling effect can exist between the first antenna 100 and the second antenna 200, which leads to a low isolation level between the first antenna 100 and the second antenna 200. Thus, the first antenna 100 and the second antenna 200 may need to be isolated.

The target device 300 can be arranged at a third position. This target device 300 can be configured to generate a third RF signal 301 in the target frequency band. The third RF signal 301 can be used to reduce the impact of the first RF signal 101 on the second antenna 200 receiving the second RF signal 201. That is, the third RF signal 301 can be used to the impact of the first RF signal 101 radiated by the transmission antenna on the receiving antenna receiving the second RF signal 201. That is, the third RF signal 301 can be used to suppress the interference of the first RF signal 101 on the signal reception of the second antenna 200. The third position can be different from the second position and the first position. Since the second position is different from the first position, the first position, the second position, and the third position may not overlap with each other. Thus, the positions of the first antenna 100, the second antenna 200, and the third antenna may not overlap with each other. FIG. 2 shows that the electronic device is a laptop. In some other embodiments, the electronic device can also include an electronic device other than the laptop, such as a cell phone, a tablet, etc., which is not limited here. When the electronic device is a laptop, 01 represents the body of the laptop, 001 represents the screen side of the laptop, and 002 represents the keyboard side of the laptop.

Based on the above, the electronic device can be configured to reduce the impact of the first RF signal 101 on the second antenna 200 receiving the second RF signal 201 through the third RF signal 301 generated by the target device 300. That is, the impact of the first RF signal 101 radiated by the transmission antenna on the signal reception of the receiving antenna can be suppressed by the third RF signal 301 generated by the target device 300. Then, the target device 300 can be configured to suppress the interference and isolate the signals between the first antenna 100 and the second antenna 200 to effectively solve the signal interference problem during the antenna communication, which improves the communication efficiency and reliability of the electronic device.

The third RF signal 301 can be a signal of a specific form and can be related to the first RF signal 101 and the second RF signal 201. If the impact of the first RF signal 101 on the signal reception of the second antenna 200 needs to be suppressed, the third RF signal 301 can be a signal having a 180° phase difference with the first RF signal to cancel the second RF signal 201.

The target device 300 can be a device configured to generate and/or transmit the third RF signal 301, such as a metamaterial structure, or an antenna structure except the first antenna 100 and the second antenna 200 can be referred to as the third antenna, or an integrated circuit. If the target device 300 is a metamaterial structure, the metamaterial structure can be made of an open resonator, a metallic short wire, or a combination thereof.

If the target device 300 is the above third antenna, the third antenna can radiate the third RF signal 301. The third RF signal 301 can have a 180° phase difference with the first RF signal 101 to cancel the first RF signal 101, or a 180° phase difference with the second RF signal 201 to cancel the second RF signal 201. In addition, since the third antenna has the communication function, the third antenna can be used as an isolation device for the first antenna 100 and the second antenna 200 and can also perform the communication function of the third antenna. Thus, the third antenna can be configured to communicate to allow the electronic device to use the first antenna, the second antenna, and the third antenna to operate, while using the third antenna to better isolate the first antenna 100 and the second antenna 200 to improve the communication performance of the electronic device.

The type of the target device 300 may not be limited here. That is, those skilled in the art can set and adjust the type of the target device 300 as needed. The above merely illustrates the examples of the target device and does not limit the type of the target device as long as the target device 300 can generate the third RF signal 300. Thus, those skilled in the art can set and adjust the type of the target device 300 as needed.

Based on the above, in some embodiments of the present disclosure, a first antenna path of the first antenna 100 being connected to the transceiver through a feed point of the first antenna 100 may not include the target structure forming the target device 300. A second antenna path of the first antenna being connected to a connection point representing a reference ground of the electronic device through a ground point of the first antenna 100 may not include the target structure forming the target device 300. That is, the first antenna 100 can form a first antenna path connection with the transceiver through the feed point, but the first antenna path does not include the target structure forming the target device 300. The first antenna 100 can be connected to the ground point of the electronic device to form the second antenna path through the ground point of the first antenna 100, but the second antenna path does not include the target structure forming the target device 300. That is, the feed point and the ground point of the first antenna 100 may not be connected to the target device 300, and the first antenna 300 may not be connected to the target device 300.

In addition, a third antenna path of the second antenna 200 being connected to the transceiver through the feed point of the second antenna 200 may also not include the target structure forming the target device 300. A fourth antenna path of the second antenna 200 being connected to the ground point representing the reference ground of the electronic device through the ground point of the second antenna 200 may also not include the target structure forming the target device 300. That is, the second antenna 200 can be similar to the first antenna 100, the feed point and the ground point of the second antenna 200 may not be connected to the target device 300, and the second antenna 200 may not be connected to the target device 300. The transceiver can be a communication device. The transceiver can be used as a transmission antenna based on the first antenna 100 and a receiving antenna based on the second antenna 200. Information can be encoded into an electrical signal to be transmitted by the first antenna 100 in the form of a radio wave. Moreover, the transceiver can also receive a radio wave from the second antenna 200 and convert the radio wave into an electrical signal. The electrical signal can be decoded to restore the information.

Based on the above, the target device 300 may not be connected to the first antenna 100 and the second antenna 200. Moreover, the first antenna 100, the second antenna 200, and the target device 300 do not overlap with each other. Thus, the target device 300 can be independent of the first antenna 100 and the second antenna 200.

As shown in FIG. 1, if the decoupling network is used to perform isolation, two corresponding decoupling networks exist. For example, the decoupling network may exist in the first antenna path from the feed point of the first antenna 100 to the transceiver, and the decoupling network may also exist in the second antenna path from the feed point of the second antenna 200 to the transceiver. In some other embodiments, the decoupling network may exist in the third antenna path formed by connecting the ground point of the first antenna 100 to the ground point of the electronic device, and the decoupling network may exist in the fourth antenna path formed by connecting the ground point of the second antenna 200 to the ground point of the electronic device. Thus, if the decoupling network is used to perform the isolation, a plurality of decoupling networks may be needed to take a certain space structure.

As shown in FIG. 3, the isolation between the first antenna 100 and the second antenna 200 of the electronic device can be realized by the target device 300. The electronic device of the present disclosure can reduce the space taken by the isolation structure and improve the space utilization of the electronic device. In addition, the decoupling network may be made of a series of transmission wires, filters, or other passive/active components, which causes signal transmission loss for the decoupling network. Since the target device 300 is independent of the first antenna 100 and the second antenna 200 and does not have a connection relationship with the first antenna 100 and the second antenna 200, and the signal is transmitted through space, the transmission loss caused by the decoupling network can be avoided.

Based on the above, in embodiments of the present disclosure, the electromagnetic wave of the third RF signal 301 can interact with the electromagnetic wave of the first RF signal 101 to reduce the impact of the first RF signal 101 on the second antenna 200 receiving the second RF signal 201. The third RF signal 301 can be transmitted by a device of the third antenna 300 or the integrated circuit capable of actively transmitting the third RF signal or passively transmitted by the metamaterial structure based on the first RF signal, which is determined as needed.

Based on the above, the electronic device can generate and transmit the electromagnetic wave carrying the third RF signal through the target device 300. The electromagnetic wave of the third RF signal 301 can interact with the electromagnetic wave carrying the first RF signal 101 to reduce the impact of the first RF signal 101 on the second antenna 200 receiving the second RF signal 201. The electromagnetic wave of the third RF signal 301 interacting with the electromagnetic wave carrying the first RF signal 101 can include that the electromagnetic wave carrying the third RF signal 301 has a phase difference with the electromagnetic wave carrying the first RF signal 101. The phase difference can be 180°. Thus, the electromagnetic wave carrying the third RF signal 301 can have an inverse interference with the electromagnetic wave carrying the first RF signal 101 to suppress the first RF signal 101 from being transmitted to the second antenna 200. The first RF signal 101 can be suppressed to be received by the feed point of the second antenna 200 and transmitted to the transceiver via the feed point of the second antenna 200. Thus, the impact of the first RF signal 101 on the second antenna 200 receiving the second RF signal 201 can be further reduced.

Most or a majority of the electromagnetic waves of the third RF signal can have a phase difference of approximately 180° from the electromagnetic waves of the first RF signal. However, in the present disclosure, all electromagnetic waves of the third RF signal are not limited to having a phase difference of 180° with all electromagnetic waves of the first RF signal.

In some embodiments, the phase difference between the electromagnetic wave carrying the third RF signal and the electromagnetic wave carrying the first RF signal can be 180°. Crests and troughs of two electromagnetic waves can be symmetrical at each moment. Thus, if the two electromagnetic waves overlap at a space point, the two electromagnetic waves can cancel each other out, because the crest of one wave corresponds to the troughs of the other wave.

In some other embodiments, the phase difference between the electromagnetic wave carrying the third RF signal and the electromagnetic wave carrying the first RF signal can be approximately 180°. The phase difference between the two waves can deviate from 180° due to various factors (e.g., the non-uniformity of a propagation medium or instability of a wave source). Thus, the two waves may not completely cancel each other out when the two waves overlap instead of a relatively small composite wave can be generated. The relatively small composite wave can also be used to reduce the impact of the first RF signal on the second antenna receiving the second RF signal.

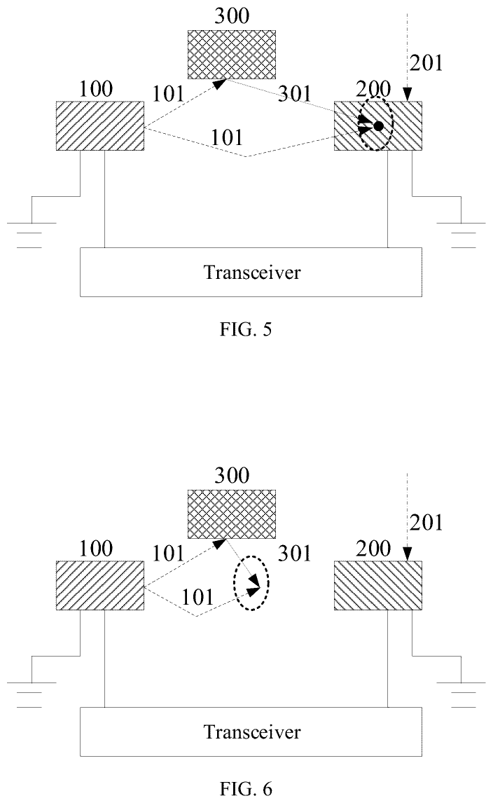

The destructive interference between the electromagnetic wave carrying the third RF signal 301 and the electromagnetic wave carrying the first RF signal 101 is illustrated in FIGS. 3 to 5. FIG. 4 shows the destructive interference of the third RF signal 301 and the first RF signal 101 occurring around the second antenna 200. FIG. 5 shows the destructive interference of the third RF signal 301 and the first RF signal 101 occurring at the feed point of the second antenna 200. FIG. 6 shows the destructive interference of the third RF signal 301 and the first RF signal 101 occurring around the second antenna 200 occurring at a position far away from the second antenna 200.

As shown in FIG. 4-6, the third RF signal and the first RF signal can interact at various locations, as long as the first RF signal 101 is suppressed from being received by the feed point of the second antenna 200. Thus, the target device 300 can be set in various ways to satisfy requirements of various application scenarios and have a strong adaptability.

The interaction positions shown in FIGS. 4-6 illustrate the locations of the above three interaction situations and do not limit the above corresponding locations of the above three situations. In addition, the electromagnetic wave carrying the third RF signal 301 can interact with the electromagnetic wave carrying the first RF signal 101, which is not limited to the above destructive interference and can include other interactions, as long as the impact of the first RF signal on the second antenna receiving the second RF signal 201 can be reduced.

Based on the above, in some embodiments, the target device 300 can be configured to change the time at which the induced induction current passes by and form the third RF signal 301 at the target frequency band. That is, the target device 300 can be a device that passively generates the third RF signal 301 based on the first RF signal 101, e.g., a metamaterial structure, which is not limited.

The induction current can be used to represent the electromagnetic wave of the first RF signal 101. Since when the electromagnetic wave carrying the first RF signal 101 is transmitted to the target device 300, the target device 300 can be caused to generate the induction current based on the first RF signal 101. Thus, the induction current can be used to represent the electromagnetic wave of the first RF signal 101.

Since the induction current can represent the electromagnetic wave of the first RF signal 101, the target device 300 changing the time at which the induced induction current passes by can be after the first RF signal 101 radiated by the first antenna 100 is received by the target device 300. In some other embodiments, when the first RF signal 101 radiated by the first antenna 100 passes the target device 300, the target device 300 can induce the first RF signal 101 to form the induction current inside. Since the third RF signal 301 generated by the target device 300 is generated according to the induction of the first RF signal 101, the pass by time of the induction current can be changed, and the phase of the third RF signal 301 relative to the first RF signal 101 can be changed. Thus, the third RF signal 301 and the first RF signal 101 can have the phase difference. Then, the third RF signal 301 and the first RF signal 101 can cancel each other out based on the phase difference to suppress the first RF signal 101 from being received by the second antenna 200. Then, the impact of the first RF signal 101 on the second antenna 200 receiving the second RF signal 201 can be reduced, and the communication efficiency and the reliability of the electronic device can be improved.

If the target device 300 changes the time when the induced induction current passes by, the electromagnetic wave of the third RF signal 301 can have a phase difference with the electromagnetic wave of the first RF signal 101. Thus, the target device 300 changing the time when the induced induction current can at least include reducing the time when the induced induction current passes by, i.e., causing the speed of the induction current to become fast, and increasing the time when the induced induction current passes by, i.e., causing the speed of the induction current to become slow. The target device 300 causing the speed of the induction current to become slow can include causing the speed to gradually become slow or causing the induction current to pass by at an uniform slow speed. Similarly, the target device 300 causing the speed of the induction current to become fast can include causing the speed to gradually become fast or causing the induction current to pass by at an uniform fast speed. In the present disclosure, the type of the target device 300 is not limited. That is, those skilled in the art can set and adjust the type of the target device 300 as needed, as long as the target device can change the time when the induced induction current passes by.

Based on the above, in some embodiments of the present disclosure, the material of the target device 300 can be different from the material of the reference ground representing the electronic device connected to the ground point of the first antenna 100. That is, the target device 300 and the assemblies of the second antenna path can be different. The material of the target device 300 can be different from the material of the reference ground representing the electronic device connected to the ground point of the first antenna 100. That is, the material of the induction current transmission path of the first antenna 100 can be different from the material of the transmission path of the induction current in the target device 300. Thus, the speed of the induction current generated by the target device 300 based on the first RF signal 101 can change relative to the transmission speed of the current of the first antenna 100. Then, the third RF signal 301 generated according to the induction current with the changed speed can have the phase difference with the first RF signal 101. Thus, the third RF signal and the first RF signal can cancel each other out because of the phase difference. That is, the first antenna 100 and the second antenna 200 can be effectively isolated. If the target device 300 and the reference ground representing the electronic device connected to the ground point of the first antenna 100 are the same, the transmission medium of the induction current in the target device 300 can be the same as the transmission medium of the current in the first antenna 100. Then, the transmission speed of the induction current in the target device 300 can be the same as the transmission speed of the current in the first antenna 100. Then, the third RF signal 301 and the first RF signal 101 may not have the phase difference, and the first antenna 100 and the second antenna 200 cannot be isolated.

The material of the target device 300 can be different from the material of the reference ground representing the electronic device connected to the ground point of the first antenna 100. The purpose can include causing the speed of the induction current induced by the target device 300 to be different from the speed of the current corresponding to the first RF signal.

Based on this, in some embodiments of the present disclosure, the material of the target device 300 can have a resistance smaller than the resistance of the material of the ground point of the first antenna and the resistance of the material of the ground point of the electronic device. Thus, the speed of the induction current can be relatively faster. For example, the material of the ground point of the first antenna 100 connected to the reference ground representing the electronic device can be copper. The material of the target device 300 can be silver with relatively small resistance.

In some other embodiments of the present disclosure, the target device 300 can have a material with a resistance smaller than the material of the first antenna 100 and the ground point of the electronic device. Thus, the speed of the induction current can be faster. For example, the material of the ground point of the first antenna 100 connected to the reference ground representing the electronic device can be copper. The material of the target device 300 can be copper with relatively small resistance.

In some other embodiments of the present disclosure, the material of the target device 300 can have a resistance greater than the resistance of the material of the first antenna 100 and the ground point of the electronic device. Thus, the speed of the induction current can be relatively slower. For example, the material of the ground point of the first antenna connected to the reference ground representing the electronic device can be copper. The material of the target device 300 can be iron or aluminum with a relatively large resistance.

In the present disclosure, the material of the target device 300 and the material of the reference ground representing the electronic device are not limited. That is, those skilled in the art can set and adjust the type of the target device 300 as needed. The above situation illustrates the types of materials of the target device 300 and the reference ground representing the electronic device, which is not limited to the description of embodiments of the present disclosure.

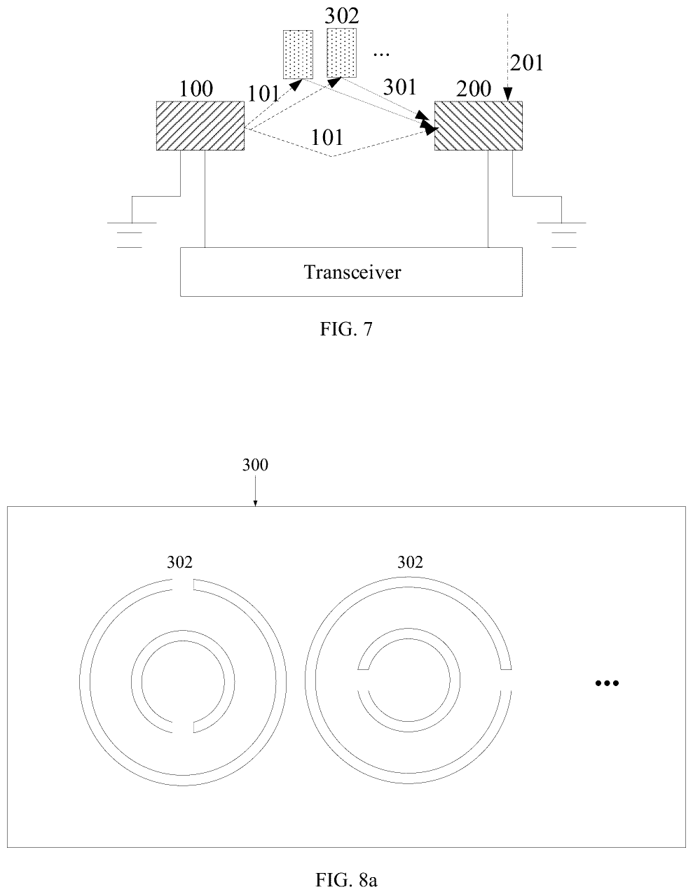

Based on the above, in some embodiments of the present disclosure, as shown in FIG. 7, the target device 300 includes a plurality of target structures 301 configured to form the third RF signal 302 of the target frequency band. Each target structure 302 is configured to realize the inductance effect of the target frequency band and generate an impedance for the electromagnetic wave carrying the target frequency band transmitted to the target device 300. Then, the speed of the induction current can be changed. The electromagnetic wave having the phase difference with the original electromagnetic wave, i.e., the electromagnetic wave carrying the target frequency band, can be generated.

The number of the plurality of target structures 302 can be related to the time of the induced induction current passing by. That is, the number of the plurality of target structures can control the speed of the induction current to cause the speed of the induction current to become fast or slow. Thus, the phase difference between the third RF signal 301 and the first RF signal 101 can be controlled. Then, the third RF signal 301 and the first RF signal 101 can cancel each other out. Therefore, the first antenna 100 and the second antenna 200 can be effectively isolated.

Since the target device 300 includes the plurality of target structures 302, each target structure 302 can correspond to the inductance effect generated by the electromagnetic waves of different frequencies in the target frequency band. Then, the electromagnetic wave having a phase difference with the electromagnetic wave of a different frequency in the target frequency band can be generated. Then, the first antenna 100 and the second antenna 300 can be isolated. The plurality of target structures 302 can be configured to determine the frequency bands corresponding to the target structures 302 during setting according to the frequency range of the target frequency band and the frequency of the third RF signal. Moreover, when the frequency bands corresponding to the target structure 302 are different, the target structure 302 can have different structures according to the corresponding different frequency bands.

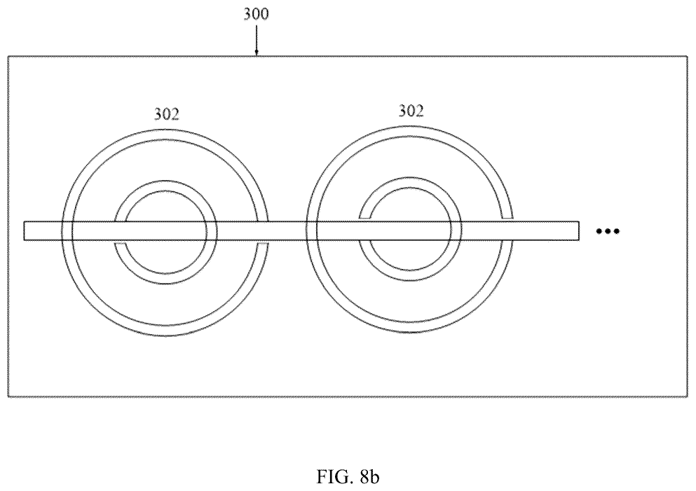

For example, in some embodiments of the present disclosure, the target device 300 can be made of a plurality of open resonators. The open resonator can be a target structure 302. As shown in FIG. 8a, the opening positions of the open resonators in the target device 300 corresponding to the different frequency bands are different. However, FIG. 8a illustrates the open resonator of the target device 300 and does not limit the structure of the open resonator. The opening position of the open resonator can be determined as needed.

In embodiments of the present disclosure, the target device 300 can have different response features for electromagnetic waves of different frequency bands. By adjusting the opening position of the open resonator, the absorption and/or reflection features of the target device 300 to the specific frequency band signal can be controlled. Thus, the signals of the plurality of frequency bands can be effectively processed.

In some other embodiments of the present disclosure, the target device 300 can also be made of the plurality of open resonators and metal wires. The combination of an open resonator and metal wires can be a target structure 302. As shown in FIG. 8b, the opening positions of the open resonators in the target device 300 corresponding to different frequency bands can be different, and the connection methods for the metal wires of the different frequency bands can be different in the target device 300. However, FIG. 8b only illustrates the schematic diagram of the combination of the open resonator structure and the metal wires in the target device 300 and does not limit the combination of the open resonator structure and the metal wires. The combination of the open resonator structure and the metal wires can be determined as needed.

The combination structure of embodiments of the present disclosure can have the ability to process a more complex signal. The combination of the open resonator and the metal wires can be configured to effectively respond to the specific frequency band and adjust the transmission path of the electromagnetic wave or generate an additional resonance feature through the metal wires. The combination of the open resonator and the metal wires can be configured to more precisely control the transmission and processing of the signal. Thus, the control ability of the system for the signal can be improved with such configuration, and the flexibility and efficiency of the signal processing can be enhanced.

In addition, the number of the plurality of the target structures 301 can be related to changing the time when the induced induction current passes by. That is, different numbers of the target structures 301 can cause the speed of the induction current corresponding to the third RF signal 301 to be different. Thus, the plurality of target structures 301 can also be configured to precisely adjust the speed of the induction current to further precisely adjust the phase difference between the third RF signal 301 and the first RF signal 101 to improve the isolation effect between the first antenna 100 and the second antenna 200.

The target device 300 can be arranged between the first antenna 100 and the second antenna 200 and can be configured to isolate the first antenna 100 and the second antenna 200. However, the distance between the target device 300 and the first antenna 100 can have a certain requirement. When the distance is too small, the signal radiation efficiency of the first antenna 100 can be affected. When the distance is too large, the induction current cannot be generated according to the first RF signal 101, and the isolation may not work. Thus, in some embodiments of the present disclosure, the third position of the target device 300 can include one of the following.

The third position of the target device 300 can be at a position of ¼ of the wavelength of the base frequency of the target frequency band. That is, the distance between the target device 300 and the first antenna 100 can be ¼ of the wavelength of the base frequency.

In some other embodiments, the third position of the target device 300 can be located at a position greater than ¼ of the wavelength of the base frequency of the target frequency band and smaller than 3 times the wavelength of the base frequency of the target frequency band. That is, the distance between the target device 300 and the first antenna 100 can range from ¼ to 3 times the wavelength.

The base frequency of the target frequency band can be the center wavelength of the target frequency. Since the target frequency band corresponds to the electromagnetic wave in a frequency range, e.g., 5 GHz to 7 GHz. If the wavelength corresponding to 5 GHz is selected, the isolation effect cannot be satisfied for the electromagnetic wave of 7 GHz. When the wavelength corresponding to 7 GHz is selected, a similar situation may exist. Thus, the wavelength corresponding to the center frequency can be selected, e.g., the wavelength corresponding to 6 GHz. Thus, the electromagnetic waves of the whole target frequency band can be considered as much as possible to achieve a good isolation effect. In addition, the distance between the target device 300 and the first antenna 100 can be the distance between the target device 300 and the first antenna 100 along the arrangement direction of the first antenna 100 and the second antenna 200.

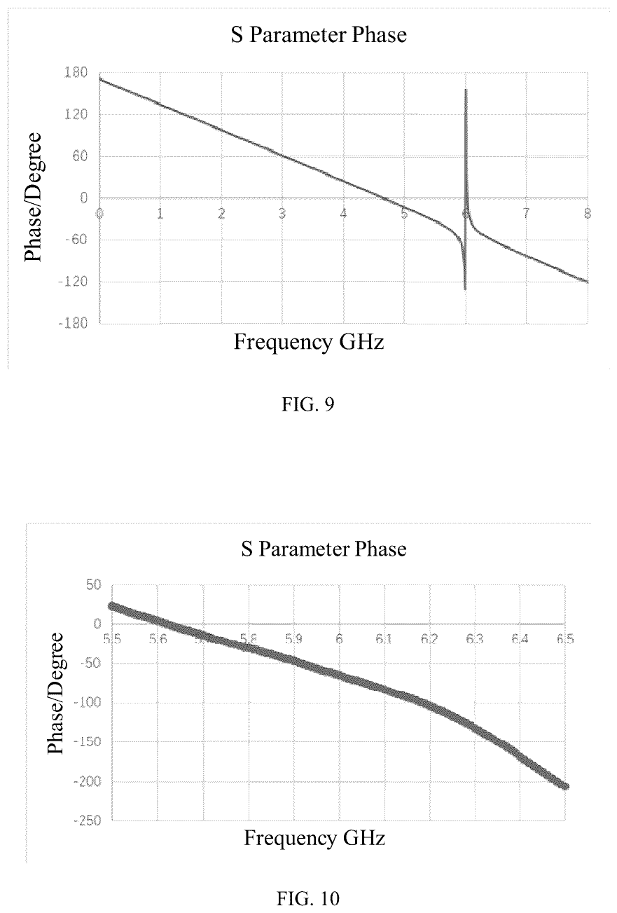

FIG. 9 illustrates a schematic diagram showing an operation curve of an antenna module of an electronic device according to some embodiments of the present disclosure. The abscissa is the operating frequency, and the ordinate is the electromagnetic wave phase. If the target device 300 is a metamaterial structure, the metamaterial structure is configured to cause the electromagnetic wave transmitted to the metamaterial structure to have a phase mutation to realize any phase difference as shown in FIG. 9. In addition, as shown in FIG. 9, when the metamaterial structure operates near 6 GHz, the electromagnetic wave can have a phase mutation. However, FIG. 9 is merely an example, which is not limited to the present disclosure and is determined as needed.

The phase mutation of the electromagnetic wave carrying the first radio frequency signal transmitted to the above metamaterial structure and the vacuum wave vector of the electromagnetic wave carrying the first radio frequency signal, and the perpendicular distance from the metamaterial structure to the center point of the connection line between the first antenna 100 and the second antenna 200 can be related to an incident angle when the electromagnetic wave carrying the first RF signal transmitted to the metamaterial structure, i.e., the target device 300. The vacuum wave vector of the electromagnetic wave carrying the first RF signal can be a determined value, while the perpendicular distance from the metamaterial structure to the center point of the connection line between the first antenna 100 and the second antenna 200 and the incident angle when the electromagnetic wave carrying the first RF signal 101 is transmitted to the metamaterial structure, i.e., the target device 300, are changing values. The perpendicular distance and the incident angle can represent the third position of the target device 300. Thus, the third position of the target device 300 can be adjusted to realize the phase mutation of the first RF signal 101 to obtain the third RF signal 301.

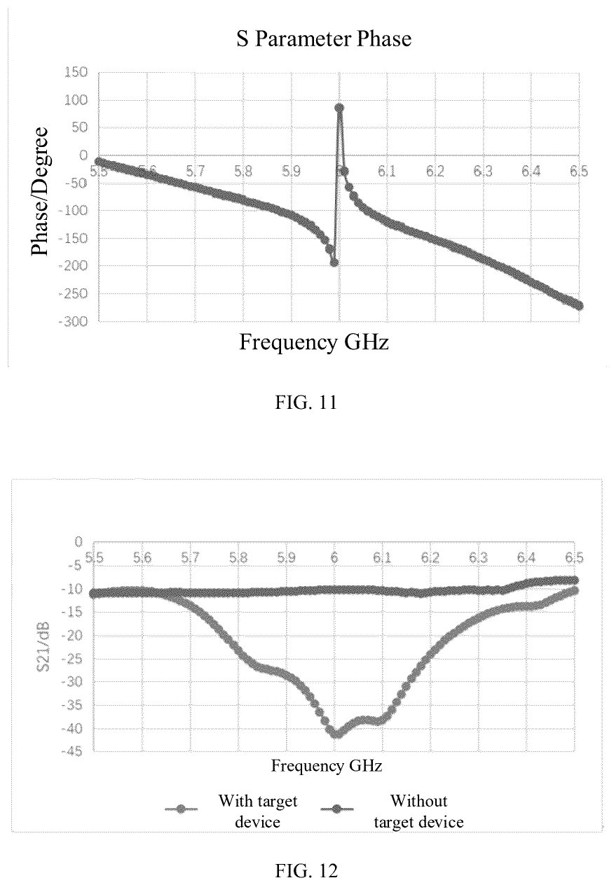

In some embodiments, a phase difference Φ₁ between the first antenna 100 and the second antenna 200 can be first obtained without the metamaterial structure, i.e., the phase difference between the first RF signal and the second RF signal as shown in FIG. 10. Then, by using the feature of the metamaterial structure causing the electromagnetic wave to have the phase mutation, the suitable metamaterial structure can be designed, and the third position of the metamaterial structure can be adjusted. Thus, when the metamaterial structure operates at the resonance frequency, e.g., 6 GHZ, the phase difference Φ₂ between the third RF signal and the first RF signal has a 180° difference with the phase difference Φ₁ between the first RF signal and the second RF signal as shown in FIG. 11. Then, as shown in FIG. 12, electromagnetic waves on two paths cancel each other out to greatly improve the isolation at the end openings of the two antennas by more than 30 dB. The phase difference Φ₁ between the first antenna 100 and the second antenna 200 can be obtained in simulation methods or a practical test method. The difference between the phase difference Φ₁ and the phase difference Ø2 can satisfy another value requirement, which is not limited in the present disclosure and is determined as needed.

In connection with FIG. 3, in embodiments of the present disclosure, the target device 300 can be parallel with the connection line between the first position of the first antenna 100 and the second position of the second antenna 200. That is, the target device 300 faces the connection line between the first antenna 100 and the second antenna 200. Thus, the target device 300 can be located between the first antenna 100 and the second antenna 200 not on the connection line between the first antenna 100 and the second antenna 200. The incident angle when the electromagnetic wave carrying the first RF signal is transmitted to the metamaterial structure, i.e., the target device 300, may not be 0°.

In the present disclosure, the target device 300 can be arranged between the first antenna 100 and the second antenna 200 not on the connection line between the first antenna 100 and the second antenna 200. The incident angle when the electromagnetic wave carrying the first RF signal is transmitted to the target device 300 may not be 0°. In embodiments of the present disclosure, a more complex signal processing and transmission path control can be realized. The non-zero degree incident angle can be helpful in improving the processing efficiency of the signal, especially in the complex or non-standard signal transmission environment. Such configuration can be beneficial in optimizing the propagation path of the electromagnetic wave, which can enhance signal penetration or avoid certain types of interference.

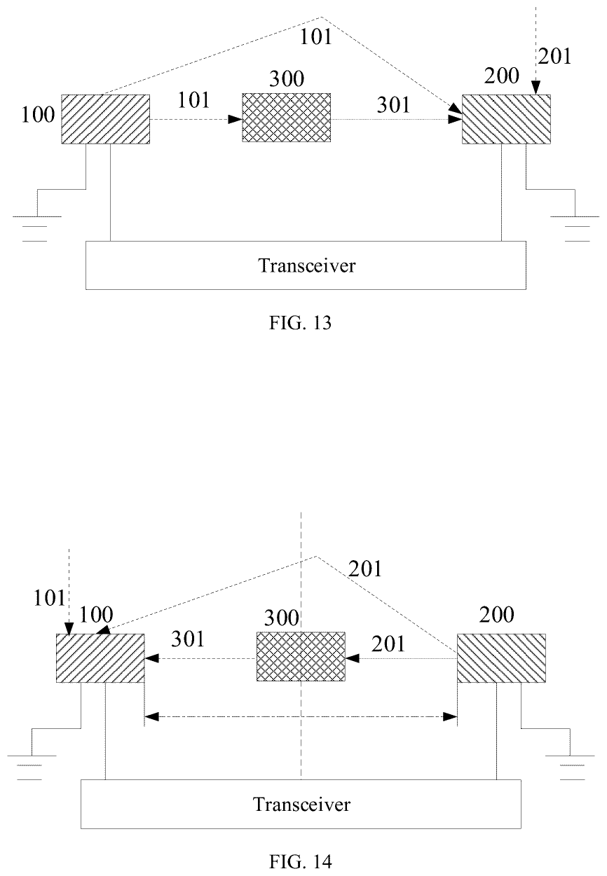

In connection with FIG. 13, in some other embodiments of the present disclosure, the third position of the target device 300, the first position of the first antenna 100, and the second position of the second antenna 200 are on a same straight line. That is, the target device 300 can be arranged between the first antenna 100 and the second antenna 200 and on the connection line between the first antenna 100 and the second antenna 200. The incident angle when the electromagnetic wave carrying the first RF signal is transmitted to the metamaterial structure, i.e., the target device 300, is 0°.

In the present disclosure, the third position of the target device 300, the first position of the first antenna 100, and the second position of the second antenna 200 are on the same straight line. The target device 300 is on the connection line between the first antenna 100 and the second antenna 200. The incident angle when the electromagnetic wave carrying the first RF signal is transmitted to the metamaterial structure, i.e., the target device 300, is basically 0°. Thus, the energy loss and interference during the signal propagation can be maximally reduced. Zero incident angle can mean that the signal can be directly transmitted to the target device, which improves the efficiency and quality of the signal reception. Thus, this configuration can be suitable for the scene requiring high efficiency and high accuracy for signal transmission. With the straight line propagation path, the signal transmission can be clearer and more stable.

For the above embodiments, after the target device 300 generates the third RF signal 301 having the phase difference with the first RF signal 101 based on the first RF signal 101 transmitted to the target device 300 when the third RF signal 301 is transmitted to the second antenna 200, the third RF signal 301 can continue to be transmitted to other assemblies of the electronic device according to the transmission direction of the first RF signal 101 transmitted to the target device 300 and can be then reflected or refracted to the second position of the second antenna 200. For example, the third RF signal 301 can be transmitted to the housing of the electronic device and can be reflected or refracted by the housing to the second antenna 200.

In addition, after the target device 300 generates the third RF signal 301 having the phase difference with the first RF signal 101 based on the first RF signal 101 transmitted to the target device 300 when the third RF signal 301 is transmitted to the second antenna 200, the third RF signal 301 can be directly transmitted to the second position of the second antenna 200 passing through the target device 300, i.e., the second antenna 200. The third RF signal 301 being directly transmitted to the second position of the second antenna 200 via the target device 300 can include the following exemplary situations.

First, the target device 300 can reflect the electromagnetic wave carrying the third RF signal 301 to cause the electromagnetic wave to be transmitted to the second position of the second antenna 200.

Second, the target device 300 can refract the electromagnetic wave carrying the third RF signal 301 to cause the electromagnetic wave to be transmitted to the second position of the second antenna 200.

Third, the target device 300 may not reflect or refract the electromagnetic wave carrying the third RF signal 301 to cause the electromagnetic wave to be directly transmitted to the second position of the second antenna 200.

When the target device 300 faces the connection line between the first antenna 100 and the second antenna 200, the first and second situations can be applied. When the target device 300 is on the connection line between the first antenna 100 and the second antenna 200, the third situation can be applied.

In embodiments of the present disclosure, the relative positions between the target device 300 with the first antenna 100 and the second antenna 200 are not limited. That is, those skilled in the art can set and adjust as needed. The above situations are merely examples to illustrate the possible relative positions between the target device 300 with the first antenna 100 and the second antenna 200. The possible relative position is not limited to the above situations. Those skilled in the art can adjust according to the actual spatial condition of the electronic device.

Based on the above, the first antenna 100 can be used as a transmission antenna, and the second antenna can be used as a receiving antenna. However, the first antenna 100 can be used as a transmission antenna and a receiving antenna simultaneously. Similarly, the second antenna 200 can also be used as a transmission antenna and a receiving antenna simultaneously. Based on this, in embodiments of the present disclosure, the first antenna 100 can be used as a receiving antenna to receive a fourth RF signal of the target frequency band, and the second antenna 200 can be used as a transmission antenna to radiate a fifth RF signal of the target frequency band. The target device 300 can be configured to generate a sixth RF signal of the target frequency band. The sixth RF signal can be used to reduce the impact of the fifth RF signal on the fourth RF signal. The principle of using the sixth RF signal to reduce the impact of the fifth RF signal on the first antenna 100 receiving the fourth RF signal can be the same as the principle of using the third RF signal 301 to reduce the impact of the first RF signal 101 on the second antenna 200 receiving the second RF signal, which is not repeated here.

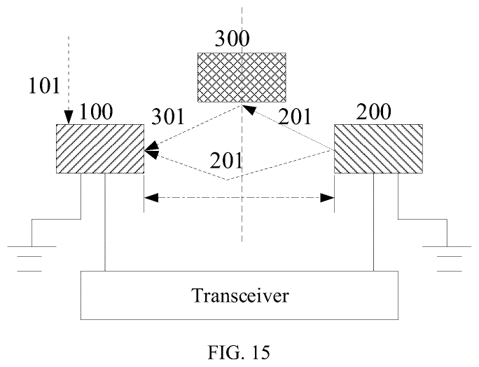

As shown in FIG. 14 and FIG. 15, the third position of the target device 300, the first position of the first antenna 100, and the second position of the second antenna 200 are on the same straight line, and the third position is in the center of the first position and the second position. That is, the target device 300 can be arranged at the center point of the connection line between the first antenna 100 and the second antenna 200. Then, the target device 300 can act on the electromagnetic wave carrying the first RF signal 101 and also act on the electromagnetic wave carrying the fifth RF signal. That is, the target device 300 can be reused. Thus, one target device 300 can be configured to isolate the antennas when the first antenna 100 is used as the transmission antenna and the second antenna 200 is used as the receiving antenna, and also isolate the antennas when the second antenna 200 is used as the transmission antenna and the first antenna 100 is used as the receiving antenna without an additional target device. Thus, the space required to realize the antenna isolation can be reduced, and the space utilization of the electronic device can be improved.

In summary, the present disclosure provides an electronic device. The electronic device can include a first antenna, a second antenna, and a target device. The first antenna can be a transmission antenna radiating the first RF signal of the target frequency band. The second antenna can be a receiving antenna receiving the second RF signal of the target frequency band. The target device can be configured to generate the third RF signal of the target frequency band. The third RF signal can be used to reduce the impact of the first RF signal on the second antenna receiving the second RF signal. Thus, the target device can have an interference suppression function and a signal isolation function between the first antenna and the second antenna. Therefore, the signal interference during the antenna communication can be effectively solved, and the communication efficiency and reliability of the electronic device can be improved.

Embodiments of the present disclosure are described in a progressive manner, a parallel manner, or a combination thereof. Each embodiment focuses on the differences from other embodiments. The same or similar areas of embodiments of the present disclosure can refer to each other. Since device embodiments of the present disclosure correspond to the method embodiments of the present disclosure, the description is relatively simple. For the relative places, reference can be made to the description of the method embodiments.

The directional or positional relationship indicated by terms such as “up,” “down,” “top,” “bottom,” “inside,” and “outside” are based on the direction or position relationship shown in the accompanying drawings, which merely facilitates the description of the present disclosure and the simplification of the description and does not indicate or imply that the devices or elements must have certain directions or be constructed or operated in a certain orientation. Thus, the terms do not limit the present disclosure. When an assembly is connected to another assembly, the assembly can be directly connected to the another assembly, or an intermediate assembly can exist therebetween.

In the present disclosure, relational terms such as first and second are only used to distinguish one entity or operation from another entity or operation and do not necessarily require or imply that these entities or operations have any such actual relationship or sequence. Furthermore, the terms “comprises,” “include,” or any other variations thereof are intended to cover a non-exclusive inclusion, such that an article or device including a series of elements includes not only those elements, but also other elements not expressly listed, or elements inherent to the article or device. When there are no more limitations, an element defined by the phrase “comprises a . . . ” does not exclude the presence of other identical elements in the article or device that includes the above-mentioned element.

The above description of embodiments of the present disclosure enables those skilled in the art to implement or use the present disclosure. Various modifications to these embodiments are apparent to those skilled in the art. The generic principles defined here can be realized in other embodiments without departing from the spirit or scope of the present disclosure. Therefore, the present disclosure is not to be limited to the embodiments shown here but conforms to the widest scope consistent with the principles and novel features of the present disclosure.

What is claimed is:

1. An electronic device, comprising:
a first antenna arranged at a first position and configured as a transmission antenna to radiate a first radio frequency (RF) signal of a target frequency band;
a second antenna arranged at a second position different from the first position and configured as a receiving antenna to receive a second RF signal of the target frequency band; and
a target device arranged at a third position and configured to generate a third RF signal of the target frequency band, the third RF signal being used to reduce an impact of the first RF signal on the second antenna receiving the second RF signal, and the third position being different from the second position and the first position.

2. The device according to claim 1, wherein:
a first antenna path of the first antenna being connected to a transceiver through a feed point of the first antenna does not include a target structure forming the target device; and
a second antenna path of the first antenna being connected to a connection point representing a reference ground of the electronic device through a ground point of the first antenna does not include the target structure forming the target device; and/or
a third antenna path of the second antenna being connected to the transceiver through a feed point of the second antenna does not include the target structure forming the target device; and
a fourth antenna path of the second antenna being connected to the connection point representing the reference ground of the electronic device through a ground point of the second antenna does not include the target structure forming the target device.

3. The device according to claim 1, wherein an electromagnetic wave of the third RF signal interacts with an electromagnetic wave of the first RF signal to reduce the impact of the first RF signal on the second antenna receiving the second RF signal.

4. The device according to claim 3, wherein the target device is configured to change time when an induced induction current passes by to form the third RF signal of the target frequency band, and the induction current represents the electromagnetic wave of the first RF signal.

5. The device according to claim 4, wherein a material of the target device is different from a material of the reference ground representing the electronic device connected to the ground point of the first antenna.

6. The device according to claim 5, wherein the target device includes:
a plurality of target structures configured to form the third RF signal of the target frequency band, each target structure realizing an inductive effect of the target frequency band, and a number of the plurality of target structures being related to changing the time when the induced induction current passes by.

7. The device according to claim 5, wherein the third position of the target device corresponds to one of:
a position at ¼ of a wavelength of a base frequency of the target frequency band; or
a position greater than ¼ of a wavelength of a base frequency of the target frequency band and less than three times the wavelength of the base frequency of the target frequency band.

8. The device according to claim 5, wherein the target device is parallel to a connection line between the first position of the first antenna and the second position of the second antenna.

9. The device according to claim 5, wherein the third position of the target device, the first position of the first antenna, and the second position of the second antenna are on a same straight line.

10. The device according to claim 1, wherein:
the first antenna is configured as a receiving antenna to receive a fourth RF signal of the target frequency band;
the second antenna is configured as a transmission antenna to radiate a fifth RF signal of the target frequency band;
the target device is configured to generate a sixth RF signal of the target frequency band, the sixth RF signal being used to reduce an impact of the fifth RF signal on the first antenna receiving the fourth RF signal; and
the third position of the target device is on a same straight line with the first position of the first antenna, and the second position of the second antenna and is in a center between the first position and the second position.
